(19) United States
(12) Patent Application Publication
(10) Pub. No.: US 2007/0188307 A1
(43) Pub. Date: Aug. 16, 2007

(54) Wireless door intercom apparatus and system comprising same

(75) Inventors: Cheng-Shing Lai, Taipei (TW); Wan-Jun Liu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/528,457

(22) Filed: Sep. 28, 2006

(30) Foreign Application Priority Data
Feb. 16, 2006 (TW) 095105220

(51) Int. Cl. G07C 11/00; G05B 19/00; H04N 7/14; H04M 9/00

(52) U.S. Cl. 340/286.06; 379/167.01; 340/5.61; 348/14.02

(57) ABSTRACT

A wireless door intercom system comprises a wireless door intercom apparatus affixed to the entrance of a building and a portable wireless signal transceiver. The wireless door intercom apparatus comprises an audio transmission module for receiving sound and converting same into a first audio signal and a wireless signal transceiver module for converting an image signal and the first audio signal into a transmission signal which is in turn transmitted to the portable wireless signal transceiver. An audio transceiver of the portable wireless signal transceiver is adapted to receive a second audio signal input which is in turn transmitted to the audio transmission module. The wireless door intercom apparatus is also adapted to receive a lock open signal generated by a keypad of the portable wireless signal transceiver so as to remotely enable a lock controller of the wireless door intercom apparatus to open a lock connected to the wireless door intercom apparatus.

### FIELD OF THE INVENTION

The present invention relates to door intercom. More particularly, the invention relates to a wireless door intercom apparatus and a system thereof.

### BACKGROUND OF THE INVENTION

A conventional door intercom device comprises a door intercom apparatus and a residential master station. Typically, the door intercom apparatus is mounted on a position proximate the entrance (e.g., door) of a building and comprises a camera and a telephone set both electrically connected to an external power source such that power can be fed from the power source to the components of the door intercom apparatus. An electrical wiring is interconnected the door intercom apparatus and the residential master station inside the house of the building. The residential master station comprises a picture monitor and a microphone and speaker unit. In response to a visitor pressing a call button of the door intercom apparatus, the visitor can talk with a resident by means of the telephone set. Also, the resident can see the visitor from the screen of the picture monitor and talk with the visitor by means of the microphone and speaker unit. The resident then may press a push button of the residential master station to enable an electric lock on the door to open for allowing the visitor to come in after confirming the identification of the visitor.

However, the conventional door intercom device suffered from several disadvantages. For example, the residential master station is required to mount on a specific location (e.g., the wall) of the house. Thus, the resident may be not audibly aware of the ring when the resident is at a place (e.g., balcony or bathroom) relatively away from the residential master station after the visitor pressing the call button. Hence, it is possible that either, in one example, the visitor may not have a chance to meet the resident or, in another example, the resident may miss the chance of receiving the parcel sent by the delivery employee of a parcel company. Moreover, even after hearing the ring the resident may be not able to answer the telephone in time if the resident is doing something (e.g., in the bathroom). Further, wiring of the door intercom apparatus is not desirable because an additional line is required between the door intercom apparatus and the residential master station. Such line is not only unaesthetic but also expensive. Further, it is highly possible that a poor contact may occur in the wiring of the door intercom apparatus due to humidity. Thus, it is desirable to provide a novel wireless door intercom apparatus and system comprising same in order to overcome the inadequacies of the prior art.

### SUMMARY OF THE INVENTION

The present invention provides a wireless door intercom apparatus and a system thereof. The system comprises a wireless door intercom apparatus affixed to the entrance of a building to be operated by a visitor, and a portable wireless signal transceiver to be operated by a resident. The wireless door intercom apparatus comprises an audio transmission module, a call button, a wireless signal transceiver module, and a lock controller. The portable wireless signal transceiver comprises an audio transceiver and a keypad. The audio transmission module is activated by the wireless door intercom apparatus to receive sound and convert same into a first audio signal. Further, the wireless signal transceiver module is activated to convert an image signal and the first audio signal into a transmission signal which is in turn transmitted to the portable wireless signal transceiver. The audio transceiver of the portable wireless signal transceiver is adapted to receive a second audio signal input which is in turn transmitted to the audio transmission module. The wireless door intercom apparatus is also adapted to receive a lock open signal generated by the keypad of the portable wireless signal transceiver so as to remotely enable the lock controller to open a lock connected to the wireless door intercom apparatus.

The above and other objects, features and advantages of the present invention will become apparent from the following detailed description taken with the accompanying drawings.

### BRIEF DESCRIPTION OF THE DRAWINGS

FIG. 1 is a block diagram of a preferred embodiment of the invention.

### DETAILED DESCRIPTION OF THE PREFERRED EMBODIMENTS

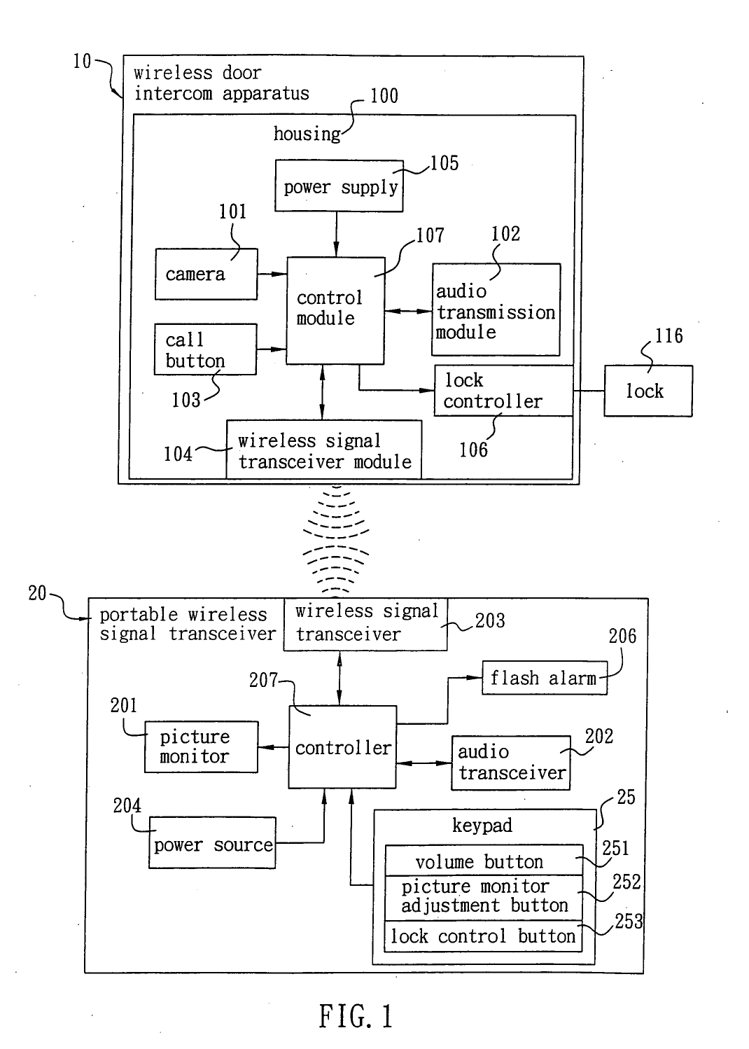

Referring to FIG. 1, a wireless door intercom apparatus and a system comprising same in accordance with a preferred embodiment of the invention are illustrated. In detail, a wireless door intercom apparatus 10 affixed to the entrance (e.g., door) of a building is remotely connected to a portable wireless signal transceiver 20 in a house to be used by a resident. The wireless door intercom apparatus 10 comprises a housing 100 including on its outer surface a camera 101, an audio transmission module (e.g., microphone and speaker unit) 102, and a call button 103. Inside the housing 100 of the wireless door intercom apparatus 10 there are further provided a control module 107, a wireless signal transceiver module 104, a power supply 105, and a lock controller 106. The control module 107 is electrically connected to all components of the wireless door intercom apparatus 10 for controlling same. The portable wireless signal transceiver 20 rings in response to pressing the call button 103. Next, the camera 101 is activated by the wireless door intercom apparatus 10 to take a picture and convert same into an image signal. Also, the audio transmission module 102 is activated by the wireless door intercom apparatus 10 to receive sound and convert same into a first audio signal. Further, the wireless signal transceiver module 104 is activated by the wireless door intercom apparatus 10 to convert both the image signal and the first audio signal into a transmission signal which is in turn transmitted to the portable wireless signal transceiver 20 by wireless.

The power supply 105 can supply power to all components of the wireless door intercom apparatus 10 for maintaining their operations. No external power source is required for the wireless door intercom apparatus 10. The power supply 105 is adapted to maintain the operation of the wireless door intercom apparatus 10 when power is out. The lock controller 106 is electrically connected to a lock 116 of the wireless door intercom apparatus 10. The lock 116 can be open (i.e., unlocked) by activating the lock controller 106. Thus, an additional line is not required to mount inside a house in installing the wireless door intercom apparatus 10. As a result, a poor contact occurring in the wiring as experienced in the prior art is prevented. Further, the installation cost is reduced greatly.

Referring to FIG. 1 again, in the embodiment the portable wireless signal transceiver 20 comprises a controller 207, a picture monitor 201, an audio transceiver (e.g., microphone and speaker unit) 202, a wireless signal transceiver 203, a power source 204, and a keypad 25. The controller 207 is electrically connected to all components of the portable wireless signal transceiver 20 for controlling same. The wireless signal transceiver 203 is adapted to receive the transmission signal from the wireless signal transceiver module 104 by wireless and then is adapted to convert the received transmission signal into an image signal and a first audio signal respectively. The image signal received by the portable wireless signal transceiver 20 is then converted into pictures to be shown on the picture monitor 201. Further, the received first audio signal is sent to the audio transceiver 202. Alternatively, the audio transceiver 202 is adapted to receive a second audio signal input. The second audio signal input is then sent to the audio transmission module 102 for output by wireless when the portable wireless signal transceiver 20 is activated. As an end, a signal can be communicated between the wireless door intercom apparatus 10 and the portable wireless signal transceiver 20.

A user may press a key of the keypad 25 to open the door lock by wireless when the portable wireless signal transceiver 20 is activated. The portable wireless signal transceiver 20 further comprises a flash alarm 206. The portable wireless signal transceiver 20 issues an activation signal to the flash alarm 206 for activating same in response to receiving the ring signal. The portable wireless signal transceiver 20 further comprises the power source 204. The power source 204 is adapted to supply required power to all components of the portable wireless signal transceiver 20 for maintaining the moving operation of the portable wireless signal transceiver 20. The portable wireless signal transceiver 20 is adapted to transmit a signal to the wireless door intercom apparatus 10 or receive a signal from the same within a predetermined operating distance of the wireless signal transceiver 203 when the portable wireless signal transceiver 20 is disposed inside the house. Thus, a user (e.g., resident) may respond a potential visitor in time in an indoor environment.

Referring to FIG. 1 again, in the embodiment the keypad 25 further comprises a volume button 251, a picture monitor adjustment button 252, and a lock control button 253. A user may manipulate the volume button 251 to adjust volume of the first and second audio signals received by the portable wireless signal transceiver 20. The user may further manipulate the picture monitor adjustment button 252 to adjust brightness and contrast of an image shown on the picture monitor 201 when the image signal is received by the portable wireless signal transceiver 20 and converted into the image. The user may further manipulate the lock control button 253 to transmit a lock open signal to the control module 107 through the wireless signal transceiver 203 and the wireless signal transceiver module 104. And in turn, the control module 107 enables the lock controller 106 to open (i.e., unlock) the lock 116.

The wireless door intercom apparatus 10 can communicate with one of a variety of portable communication devices. The wireless door intercom apparatus 10 also can connect to one of a variety of portable wireless signal transceivers having a keypad and a display (e.g., mobile phone, MP3 player, portable video game machine, or baby monitor). In use, a resident may bring the portable wireless signal transceiver 20, for example, to the kitchen or the bathroom. The resident may talk with a visitor by means of the audio transceiver 202 by watching the picture shown on the picture monitor 201 in response to the visitor pressing the call button 103. Next, the resident in the kitchen or the bathroom may activate the lock controller 106 by wireless to open (i.e., unlock) the lock 116 after confirming the identification of the visitor. Thus, the resident may operate the door intercom system in situ and continue his current job without being interrupted. Therefore, as contemplated by the invention the characteristics of the invention are that each of the wireless door intercom apparatus 10 and the portable wireless signal transceiver 20 has its own power (e.g., power supply 105 or power source 204). Further, portable wireless signal transceiver 20 is not required to affix to a specific place.

While the invention herein disclosed has been described by means of specific embodiments, numerous modifications and variations could be made thereto by those skilled in the art without departing from the scope and spirit of the invention set forth in the claims.

What is claimed is:

1. A wireless door intercom apparatus affixed to an entrance of a building to be operated by a visitor, comprising:
a housing;
a call button adapted to generate a ring signal in response to being pressed;
an audio transmission module adapted to receive external sound and convert same into a first audio signal;
a wireless signal transceiver module adapted to either transmit the ring signal and the first audio signal to a portable wireless signal transceiver to be operated by a resident, and receive a second audio signal transmitted from the portable wireless signal transceiver;
a lock controller electrically connected to a lock and adapted to activate to open the lock; and
a control module electrically connected to the call button, the audio transmission module, the wireless signal transceiver module, and the lock controller for controlling same.

2. The wireless door intercom apparatus of claim 1, further comprising a camera adapted to take a picture and convert same into an image signal which is transmitted to the portable wireless signal transceiver through the wireless signal transceiver module.

3. The wireless door intercom apparatus of claim 2, wherein the wireless signal transceiver module is adapted to convert the ring signal, the image signal, and the first audio signal into a transmission signal which is transmitted to the portable wireless signal transceiver by wireless.

4. The wireless door intercom apparatus of claim 1, wherein the wireless signal transceiver module is adapted to receive a lock open signal transmitted from the portable wireless signal transceiver for activating the lock controller to open the lock.

5. The wireless door intercom apparatus of claim 2, further comprising a power supply adapted to supply power to a plurality of components of the wireless door intercom apparatus for maintaining their operations.

6. The wireless door intercom apparatus of claim 1, wherein the portable wireless signal transceiver comprises a flash alarm, and wherein the portable wireless signal transceiver is adapted to issue an activation signal to the flash alarm for activating same in response to receiving the ring signal.

7. The wireless door intercom apparatus of claim 1, wherein the portable wireless signal transceiver comprises a keypad including:
a volume button adapted to adjust the volume of the first and second audio signals received by the portable wireless signal transceiver; and
a picture monitor adjustment button adapted to adjust the brightness and the contrast of the image signal received by the portable wireless signal transceiver.

8. The wireless door intercom apparatus of claim 1, wherein the portable wireless signal transceiver is selected from the group consisting of a mobile phone, a MP3 player, a portable video game machine, and a baby monitor.

9. A wireless door intercom system comprising a wireless door intercom apparatus affixed to the entrance of a building to be operated by a visitor, and a portable wireless signal transceiver to be operated by a resident, wherein:
the wireless door intercom system includes:
a housing;
a call button adapted to generate a ring signal in response to being pressed;
an audio transmission module adapted to receive external sound and convert same into a first audio signal;
a wireless signal transceiver module adapted to either transmit the ring signal and the first audio signal to the portable wireless signal transceiver or receive a second audio signal transmitted from the portable wireless signal transceiver;
a lock controller electrically connected to a lock and adapted to activate to open the lock; and
a control module electrically connected to the call button, the audio transmission module, the wireless signal transceiver module, and the lock controller for controlling same; and
the portable wireless signal transceiver includes:
an audio transceiver adapted to receive external sound and convert same into a second audio signal; and
a keypad electrically connected to a plurality of components of the portable wireless signal transceiver for controlling same.

10. The wireless door intercom system of claim 9, further comprising a camera adapted to take a picture and convert same into an image signal which is transmitted to the portable wireless signal transceiver through the wireless signal transceiver module.

11. The wireless door intercom system of claim 10, wherein the wireless signal transceiver module is adapted to convert the ring signal, the image signal, and the first audio signal into a transmission signal which is transmitted to the portable wireless signal transceiver by wireless.

12. The wireless door intercom system of claim 9, wherein the keypad further comprises a lock control button, and wherein the wireless signal transceiver module is adapted to receive a lock open signal transmitted from the lock control button for activating the lock controller to open the lock.

13. The wireless door intercom system of claim 10, wherein the wireless door intercom apparatus further comprises a first power supply adapted to supply power to a plurality of components of the wireless door intercom apparatus for maintaining their operations.

14. The wireless door intercom system of claim 9, wherein the portable wireless signal transceiver further comprises a flash alarm, and wherein the portable wireless signal transceiver is adapted to issue an activation signal to the flash alarm for activating same in response to receiving the ring signal.

15. The wireless door intercom system of claim 14, wherein the portable wireless signal transceiver further comprises a second power supply adapted to supply power to a plurality of components of the wireless signal transceiver for maintaining their operations.

16. The wireless door intercom system of claim 9, wherein the keypad further comprises:
a volume button adapted to adjust the volume of the first and second audio signals received by the portable wireless signal transceiver; and
a picture monitor adjustment button adapted to adjust the brightness and the contrast of the image signal received by the portable wireless signal transceiver.

17. The wireless door intercom system of claim 9, wherein the portable wireless signal transceiver is a mobile phone, a MP3 player, a portable video game machine, or a baby monitor.
